(19) United States
(12) Patent Application Publication
(10) Pub. No.: US 2014/0106619 A1
(43) Pub. Date: Apr. 17, 2014

(54) SHIELD CONNECTOR

(71) Applicant: Yazaki Corporation, Tokyo (JP)

(72) Inventors: Kenichi Okamoto, Kakegawa-shi (JP); Toshiyuki Nagasawa, Kakegawa-shi (JP)

(73) Assignee: YAZAKI CORPORATION, Tokyo (JP)

(21) Appl. No.: 14/044,938

(22) Filed: Oct. 3, 2013

(30) Foreign Application Priority Data
Oct. 11, 2012 (JP) 2012-225725

(51) Int. Cl. H01R 13/6581

(52) U.S. Cl. CPC H01R 13/6581
USPC 439/607.58

(57) ABSTRACT

A shield connector to be able to improve liability of shield performance is provided. The shield connector is fixed to a metallic case having a housing including a terminal fitting and a shield shell formed of conductor provided the interior side of the housing, and the shield shell is formed in tube-shape to be able to surround a connection portion of the terminal fitting, one end of a grounding electric wire is connected to this shield shell, the grounding electric wire extends through a extending portion of the housing to the interior side of the metallic case, and the other end of the grounding electric wire is connected to an inner surface of the metallic case.

### CROSS-REFERENCE TO RELATED APPLICATIONS

The present invention is based on Japanese Patent Application No. 2012-225725, which is incorporated herein by reference.

### BACKGROUND OF THE INVENTION

1. Field of the Invention

This invention relates to a shield connector, in particular a shield connector, having a housing formed of an insulator and a shield shell formed of a conductor provided in the interior side of the housing, and fixed to one surface of an object to be connected such that it can engage the other connector.

2. Background of the Invention

Conventionally, in an automobile (especially an electric automobile and a hybrid automobile), a devices such as a motor, a battery, an inverter and so on, have been connected to each other by a shield electric wire, and a shield connector which provides an earth connection between the shield wire and a case of the device has been proposed (for example, see JP 2002-313453A). Referring to FIGS. 5 and 6, a shield connector 100 provides a housing 101 fixed to the external side of a metallic case 1 of a device, an object to be connected and a terminal fitting 3 connected to a shield wire 2 extending into the metallic case 1 so as to be held in the interior side of the housing 101. The shield connector 100 can be brought into a fitting engagement with the other connector which is not shown. The metallic case 1 is provided with an insertion hole 4, which is configured to insert a portion of the housing 101 thereinto and communicating with the inside and outside.

The housing 101 is integrally molded, and formed of insulating resin. The housing 101 includes a platy flange portion 102 fixed to an outer surface 1A of the metallic case 1 by means of a fixture, a tubular fitting portion 103 externally extending from the flange portion 102 away from the metallic case 1 and having an opened end or tip portion, a terminal-accommodating portion 104 disposed in an interior side of the fitting portion 103 and configured to accommodate the terminal fitting 3 therein, and an extending portion 105 inserted into the insertion hole 4 of the metallic case 1 to extend through the interior side of the metallic case 1, and configured to pass the shield wire 2 therethrough. The flange portion 102 is provided with a through-hole formed therein. A bolt 5 is inserted through a collar 6 provided in the through-hole, and threaded into the metallic case 1, thereby fixing the housing 101 to the metallic case 1.

Also, the fitting portion 103 of the housing 101 is provided with a tube-shaped shield shell 106 along an inner circumferential surface thereof. The shield shell 106 is formed of a metallic plate material having conductivities and is configured to surround the terminal fitting 3 of the shield connector 100 and a terminal fitting of the other connector which is connected to the shield connector 100. Also, the shield shell 106 extends toward the metallic case 1, and is provided with a flange portion 107 bent in conformity with the outer surface 1A of the metallic case 1. The flange portion 107 of the shield shell 106 is sandwiched between the flange portion 102 of the housing 101 and the outer surface 1A of the metallic case 1, and comes in close contact with the outer surface 1A of the metallic case 1 by the bolt 5 tightened, thereby allowing for electrical connection between the shield shell 106 and the metallic case 1. As such, in the case of the conventional shield connector 100, the connection portion between the terminal fittings is surrounded by the shield shell 106, thereby preventing the leakage of electromagnetic wave generated from the shield wire 2 and the penetration of external noise thereinto.

As mentioned previously, the flange portion 107 of the shield shell 106 is sandwiched between the flange portion 102 of the housing 101 and the outer surface 1A of the metallic case 1 by tightening the bolt 5, and thus comes in close contact with the outer surface 1A. For this reason, when the bolt 5 is loosened, there is a possibility that the electrical connection between the shield shell 106 and the metallic case 1 may be weakened, and shield electric current flow from the shield shell 106 to the metallic case 1 may be hindered. As a result, the shield performance of the conventional shield connector 100 may be deteriorated.

### SUMMARY OF THE INVENTION

This invention has been made under the above circumstances, and an object of the invention is to provide a shield connector which is able to improve reliability of shield performances.

The above object has been achieved by a shield connector of this invention, which includes a housing receiving a terminal fitting therein and formed of an insulator, and a shield shell formed of a conductor and disposed inside the housing. The shield connector is fixed to an one surface of an object to be connected, and capable of being brought into a fitting engagement with the other connector. The housing may include a fixed portion fixed to the one surface of the object by a fixture; a tubular portion extending from the fixed portion toward an one side of the object and having an opened end portion to be brought into a fitting engagement with the other connector; a terminal-accommodating portion disposed inside the tubular portion to accommodate the terminal fitting therein; and an extending portion inserted through an insertion hole formed in the object to extend toward an opposite side of the object. An electrical wire connected to the terminal fitting is passed through the extending portion. The shield shell is disposed inside the tubular portion and is tube-shaped to surround both the terminal fitting and an terminal fitting of the other connector connected to each other. The shield shell is connected to an one end portion of an conducting member formed of a conductor. The conducting member extends through the extending portion toward the opposite side of the object, and has the other end portion connected to a surface of the object opposed to the one surface.

Preferably, the conducting member may include a grounding electric wire, which has a core wire and an insulating covering disposed over the core wire. The core wire at an one end of the grounding electric wire may be pressed against the shield shell.

Preferably, a platy terminal may be fixed to the core wire at an opposite end of the grounding electric wire, and fixed to the surface of the object opposed to the one surface.

### BRIEF DESCRIPTION OF THE DRAWINGS

FIG. 1 is a cross sectional view of one embodiment of a shield connector in accordance with the invention.

FIG. 2 is a perspective view of the shield connector of FIG. 1, as viewed from the other side of an object to be connected.

FIG. 3 is a perspective view of the shield connector of FIG. 1, as viewed from the one side of the object to be connected.

FIG. 4 is a perspective view of a shield shell and a conducting member of the shield connector of FIG. 1.

FIG. 5 is a cross sectional view of a conventional shield connector.

FIG. 6 is a perspective view of the conventional shield connector.

### DESCRIPTION OF THE EMBODIMENTS

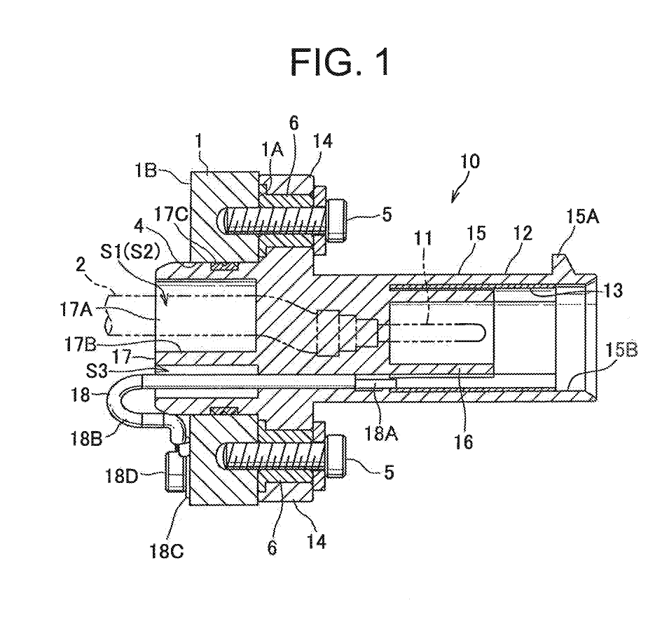

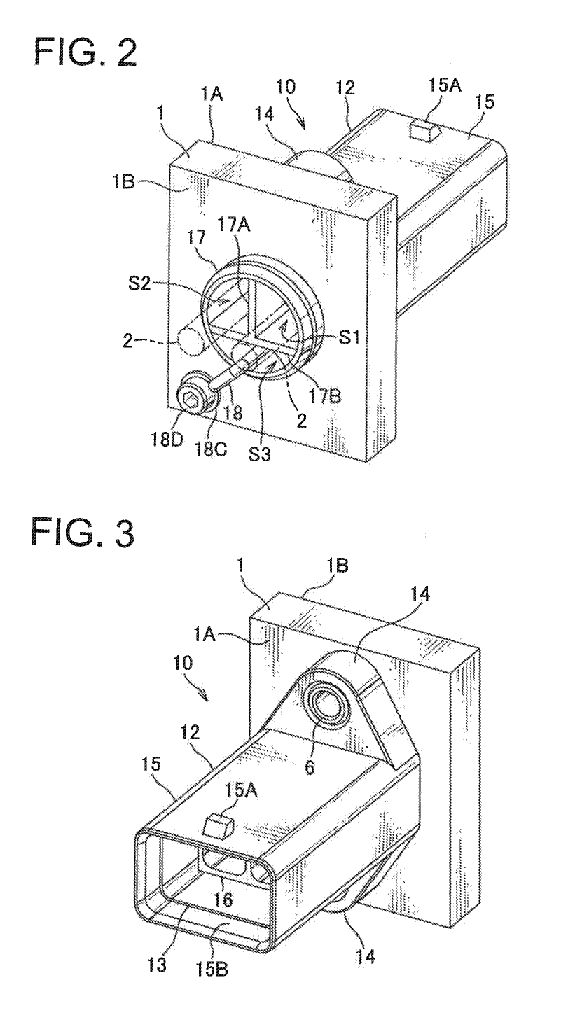

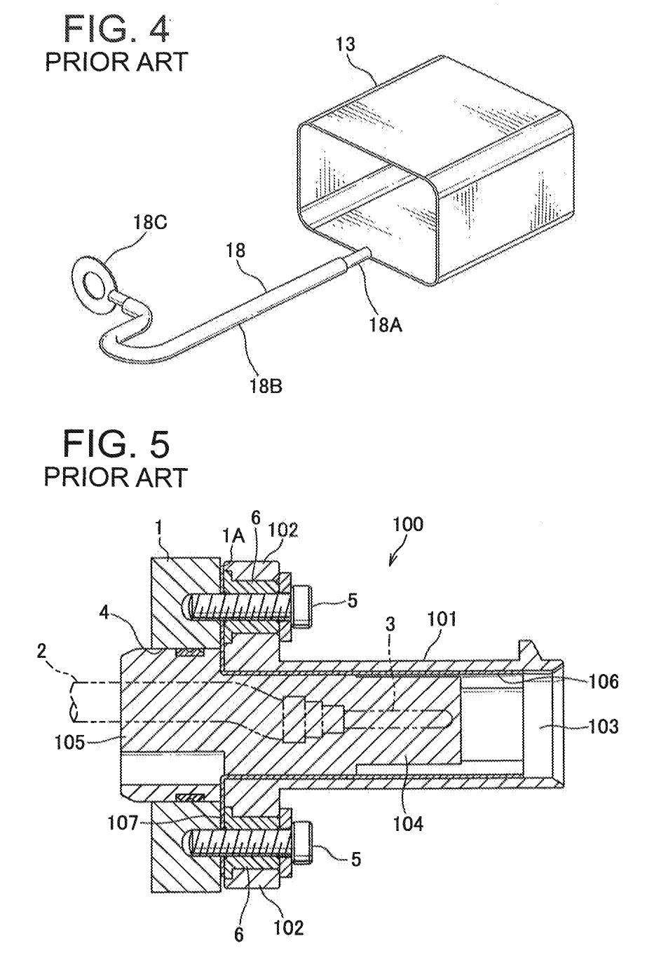

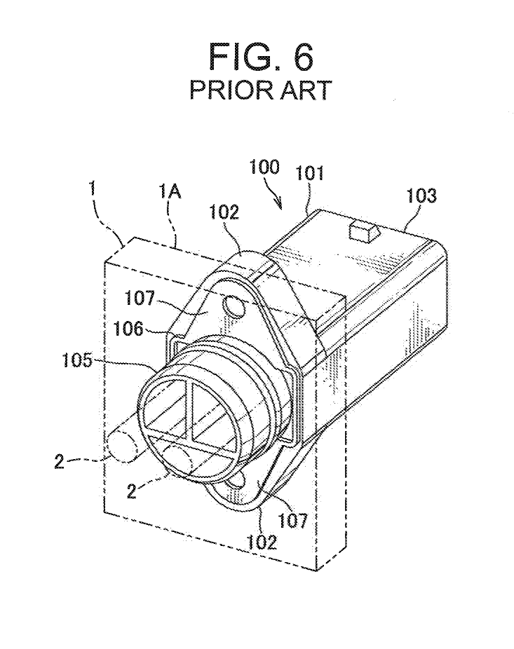

A shield connector in accordance with one embodiment of the invention is hereinafter described with reference to FIGS. 1-4. A shield connector 10 is suitable for use in a vehicle such as an electric automobile which is driven by an electric motor and a hybrid automobile which is driven by both an engine and an electrical motor. In particular, the shield connector 10 is suitable for connection between a motor and an inverter, between an inverter and a battery, and etc. by means of a shield wire. The shield connector 10, which is a male connector having a male terminal 11 as a terminal fitting therein, is configured to engage and be connected to a female connector as the other connector (not shown) having a female terminal therein. When the male connector is connected to the female connector, the shield connector 10 shields the connection portion between the male terminal and the female terminal so as to shield electromagnetic wave. As a result, the shield connector 10 can prevent the leakage and/or the penetration of noise from the connection portion.

The shield connector 10 includes a housing 12 accommodating the male terminal 11 therein and integrally formed of insulator, and a shield shell 13 formed of a conductor and disposed in the interior side of the housing 12, and is fixed to an outer surface 1A (for example, one side) of a metallic case 1, the object to be connected. The male terminal 11 is connected to a shield wire 2, which passes through the housing 12 and extends to the interior (an opposite side or the other side) of the metallic case 1, and is connected to the electric connection portion which is not shown. This shield wire 2 is obtained by covering an internal conductor by means of a shield portion such as a braid and insulating covering. The internal conductor is pressed against the male terminal 11 and is then covered with a shielding pipe and so on, thereby preventing the leakage and the penetration of electromagnetic wave from the shield wire 2.

The housing 12 includes a fixed portion fixed to the outer surface 1A of the metallic case 1 by a fixture such as a bolt 5, a tubular portion 15 extending from the fixed portion 14 toward the external side (for example, one side) of the metallic case 1, a terminal-accommodating portion 16 disposed inside the tubular portion 15 and accommodating the male terminal 11 therein, and an extending portion 17 inserted from an insertion hole 4 formed in the metallic case 1 and extending toward the interior side (for example, the other side) of the metallic case 1. The fixed portion 14 is provided with a through-hole having a collar 6. The housing 12 can be fixed to the metallic case 1 by inserting the bolt 5 through the collar 6 and threading the bolt 5 into the metallic case 1.

The tubular portion 15 has an opened end or tip portion, and can be brought into a fitting engagement with the female connector accommodated therein. Also, on the outer surface of the tubular portion 15 there is provided an engagement projection 15A, which engages a locking portion of the female connector so as to keep the engagement. A shield shell 13 is provided in conformity with the inner circumference of the tubular portion 15 inside the housing 12 such that it covers the outer circumference of the terminal-accommodating portion 16.

The terminal-accommodating portion 16 is tube-shaped with an opened tip or end portion similar to the tubular portion 15. The terminal-accommodating portion 16 is configured to retain the male connector 11 therein, and is suited for receiving the female terminal of the female connector therein. Thus, the male terminal 11 of the terminal-accommodating portion 16 and the female terminal accommodated in the terminal-accommodating portion 16 are electrically connected to each other while being in contact with each other, and the connecting portion between these terminals connected to each other is covered by the shield shell 13.

The extending portion 17 is inserted into the insertion hole 4 formed in the metallic case 1 of an approximately tubular shape from the exterior side of the metallic case 1 to the interior side of the metallic case 1, and is disposed such that its end or tip portion inwardly extends beyond the inner surface (for example, the other surface) 1B of the metallic case 1. The extending portion 17 includes partition walls 17A and 17B dividing the interior side of the extending portion 17 into three spaces S1, S2, and S3. The shield electric wire 2 apiece is inserted to each of the two spaces S1 and S2, and a grounding electric wire 18 as a conducting member as described below is inserted into the space S3. Also, a groove is circumferentially formed in the outer surface of the extending portion 17. A sealing material 17C is in close contact with the inner circumferential surface of the insertion hole 4 of the metallic case 1.

Referring to FIG. 13, the shield shell 13 is formed by molding a metal plate formed of copper alloy, aluminum alloy, and etc. into the form of substantially square tube. The shield shell 13 is pressed into the tubular portion 15 of the housing 12, as shown in FIG. 1. One end portion of the grounding electrical wire 18 as the conducting member is pressed against the end portion of the interior side of the tubular portion 15 of the shield shell 13. This grounding electric wire 18 includes the core wire 18A formed of a conductor and an insulating covering 18B disposed over the core wire 18A. The other end portion of the grounding electric wire 18 extends through the space S3 of the extending portion 17 to the interior side of the metallic case 1. A platy terminal 18C is fixed to the core wire 18A at the other end portion of the grounding electric wire 18, and is connected through a bolt 18D to the inner surface 1B of the metallic case 1. On this occasion, the other end portion side of the grounding electric wire 18 is bent in a horseshoe shape such that it is in conformity with the inner surface 1B of the metallic case 1 with adequate extra length. As such, the shield shell 13 is in ground connection with the metallic case 1 through the grounding electric wire 18.

Next, an embodiment of a procedure to couple or mount metallic case the shield connector 10 to the metallic case 1 will be described. However, the procedure is not limited to the embodiment as described below.

First, the one end portion of the grounding electric wire 18 is pressed against and fixed to the end portion of the shield shell 13, and the other end portion of the grounding electric wire 18 is passed through both the terminal-accommodating portion 16 of the housing 12 and the space S3 of the extending portion 17. Furthermore, the shield shell 13 is pressed into the tubular portion 15 of the housing 12. The other end portion of the grounding electric wire 18 passing through the space S3 is drawn from the extending portion 17, and the platy terminal 18C is fixed to this other end portion by application of pressure. After the shield shell 13 and the grounding electric wire 18 are attached to the housing 12, this housing 12 is located near the insertion hole 4 of the metallic case 1, the shield wire 2 is then drawn from the interior side of the metallic case 1 through the insertion hole 4, the male terminal 11 at the end or tip of the shield wire 2 is then inserted into the spaces S1 and S2 of the extending portion 17, and the male terminal 11 is then pressed into the terminal-accommodating portion 16 to be held therein.

Next, after the platy terminal 18C of the grounding electric wire 18 is inserted through the insertion hole 4 into the interior side of the metallic case 1, the extending portion 17 is pressed into the insertion hole 4. In this state, the sealing material 17c slides on the circumferential surface of the insertion hole 4. The extending portion 17 is pushed into the insertion hole 4, until the fixed portion 14 abuts against the outer surface 1A of the metallic case 1. Then, the bolt 5 is threaded into the metallic case 1 through the collar 6. Furthermore, a bolt 18D communicating with the platy terminal 18C is threaded into the inner surface 1B of the metallic case 1 so that the platy terminal 18C is fixed to the inner surface 1B of the metallic case 1 while maintaining a close contact with the inner surface 1B. As such, the housing 12 is fixed to the metallic case 1, and the shield shell 13 is brought into a ground connection with the metallic case 1. As a result, mounting of the shield connector 10 to the metallic case 1 is completed.

According to the exemplary embodiment as mentioned above, the other end portion of the grounding electric wire 18, which is pressed against at its one end portion to the shield shell 13, extends to the interior side of the metallic case 1, and the platy terminal 18C fixed to the other end portion of the grounding electric wire 18 is in close contact with the inner surface 1B of the metallic case and fixed to the inner surface 1B of the metallic case 1. For the reasons, it is able to secure conduction between the shield shell 13 and the metallic case 1. Therefore, even if the bolt 5 fixing the housing 12 to the metallic case 1 is loosened, the conduction between the shield shell 13 and the metallic case 1 is secured by the ground electrical wire 18. As a result, the shield electric current generated in the shield shell 13 can be securely flowed to the metallic case 1, thereby grounding the shield shell 13 to improve the reliability of the shield performance. Also, because the platy terminal 18C pressed against the other end portion of the grounding electric wire 18 is fixed through the bolt 18D to the inner surface 1B of the metallic case 1, it is able to easily fix/remove the platy terminal 18C to/from the metallic case 1 by the operation of the bolt 18D, thereby allowing for smooth attaching and detaching of the shield connector 10.

According to the exemplary embodiment as mentioned above, because the conducting member includes the grounding electric wire 18, even if the path from the shield shell 13 through the extending portion 17 of the housing 12 to the other side of the connection portion is complicated, the grounding electric wire 18 is bent as needed, thereby being suitably arranged. Furthermore, when the extending portion 17 of the housing 12 is inserted through the insertion hole 4 of the object to be connected, the grounding electric wire 18 can be biased in a desired shape in advance and be then bent toward the other surface side of the object after the insertion of the extending portion 17 into the insertion hole 4. For the reasons, one can easily and quickly perform the attaching of the shield connector 10, which would not be hindered by the grounding electric wire 18.

According to the exemplary embodiment as mentioned above, because the platy terminal 18C is fixed to the other end side of the grounding electric wire 18 and this platy terminal 18C is fixed to the other side of the connection object, it can be easily and quickly attached by using curvature and extra length of the grounding electric wire 18. Also, in the case of removing the shield connector 10 from the object to be connected, one can easily and quickly perform the removing of the shield connector 10 by removing the platy terminal 18C from the other surface of the object to be connected.

Although in the exemplary embodiment, the male connector including the male terminal 11 is used as the shield connector 10, a female connector including a female terminal can be also used as the shield connector of the invention. Also, although the above embodiment employs the metallic case 1 of a motor, a battery, an inverter, and so on used in an electric automobile and a hybrid automobile as the object to be connected, the object to be connected may be either one of the other appropriate electrical machinery and apparatus or an electrical junction box provided with electrical parts. Portions other than the metallic case 1 may be brought in an earth or grounding connection with the conducting member. Furthermore, the conducting member is not limited to the grounding electrical wire 18. For example, one end portion of a bus bar formed of metallic plate may be connected to the shield shell and the other end portion of the bus bar may be connected to the object to be connected (for example, metallic case) by means of a bolt.

The present invention has been described in terms of one or more preferred embodiments, and it should be appreciated that many equivalents, alternatives, variations, and modifications, aside from those expressly stated, are possible and within the scope of the invention.

### REFERENCE SIGNS LIST

1 metallic case (connection object)
1A outer surface (one surface)
1B inner surface (the other surface)
4 insertion hole
5 bolt
10 shield connector
11 male terminal (terminal fitting)
12 housing
13 shield shell
14 fixed portion
15 external cylinder portion
16 terminal accommodating portion
17 extending portion
18 grounding electric wire
18A core wire
18B insulated coating
18C platy terminal

What is claimed is:

1. A shield connector, comprising:
a housing receiving a terminal fitting therein and formed of an insulator; and
a shield shell formed of a conductor and disposed inside the housing, the shield connector being fixed to an one surface of an object to be connected, and capable of being brought into a fitting engagement with the other connector,
the housing comprising:
a fixed portion fixed to the one surface of the object by a fixture;
a tubular portion extending from the fixed portion toward an one side of the object and having an opened end portion to be brought into a fitting engagement with the other connector;
a terminal-accommodating portion disposed inside the tubular portion to accommodate the terminal fitting therein; and
an extending portion, inserted through an insertion hole formed in the object to extend toward an opposite side of the object, and through which an electrical wire connected to the terminal fitting is passed, wherein
the shield shell is disposed inside the tubular portion and is tube-shaped to surround both the terminal fitting and an terminal fitting of the other connector connected to each other, wherein
the shield shell is connected to an one end portion of an conducting member formed of a conductor, and wherein
the conducting member extends through the extending portion toward the opposite side of the object, and has the other end portion connected to a surface of the object opposed to the one surface.

2. The shield connector according to claim 1, wherein
the conducting member comprises a grounding electric wire, which has a core wire and an insulating covering disposed over the core wire, and wherein
the core wire at an one end of the grounding electric wire is pressed against the shield shell.

3. The shield connector according to claim 2, wherein
a platy terminal is fixed to the core wire at an opposite end of the grounding electric wire, and wherein
the platy terminal is fixed to the surface of the object opposed to the one surface.
